(19) United States
(12) Patent Application Publication
(10) Pub. No.: US 2009/0010376 A1
(43) Pub. Date: Jan. 8, 2009

(54) TRACK MOUNTED STEAM GENERATOR MAN-WAY RADIATION SHIELD DOOR SYSTEM

(76) Inventor: Earl Jacobson, Huntley, IL (US)

Correspondence Address: MATHEW R. P. PERRONE, JR., 210 SOUTH MAIN STREET, ALGONGUIN, IL, 60102-2639, US

(21) Appl. No.: 11/772,669

(22) Filed: Jul. 2, 2007

(51) Int. Cl. G21C 11/00

(52) U.S. Cl. 376/287

(57) ABSTRACT

The invention consists of placing adequate and useable shielding in the path of the radiation that exists when nuclear workers perform maintenance and inspection of the Pressure Water Reactor Steam Generator component at a nuclear electric generating plant. The shielding has an upper and a lower track member that permit the two shield panel halves to roll easily and be manipulated so that access and the associated work to be performed will result in significant reduction to the typical radiation dose that the workers receive during this work evolution when compared current shielding approach. The shielding includes rollers that roll on track members that are located above and below the man-way opening.

### CROSS REFERENCE TO RELATED APPLICATION

This application is base Provisional Application No. 60/818,424 by the same inventor.

This invention relates to a biological radiation shield apparatus and more particularly to a track mounted, steam generator, man-way radiation shield door system that reduces the radiation exposure to the workers as they perform maintenance or inspection of a steam generator, especially the primary heat transfer system of a pressure water reactor (PWR) nuclear electric generating plant.

### BACKGROUND OF THE INVENTION

This maintenance or inspection requires the opening of certain ports in the Steam Generator system of a PWR Nuclear Electric Generating Plant, thereby exposing the workers to significantly increased radiation levels.

### Field of the Invention

This invention relates generally to the field of apparatus typically defined as “shielding” against radiation in order to reduce the radiation levels and radiation exposure to the workers that are maintaining and/or inspecting PWR Steam Generator systems. The invention provides an improved apparatus for and method of shielding (reducing the radiation levels through the physics principle of attenuation) while permitting the required maintenance or inspection. The improved shielding specifically addresses the elevated radiation levels that occur when the access ports, commonly called “man-ways”, are opened in order to perform this maintenance and/or inspection.

Most reactors of this type have limited usable shielding. The main requirement that causes a limitation on the amount of shielding that can be utilized is due to the fact that the shielding has to be placed in a plane that is customarily offset approximately 25 degrees from vertical.

Typically, a radiation shield apparatus is heavy so that a radiation shielding panel as a part thereof cannot be easily moved out of the way of the opening. Weight makes it a difficult item to move without having to overcome gravity. Yet, the shield apparatus must be heavy in order to reduce the radiation exposure to nuclear workers and will overcome the deficiencies of the prior art devices.

The radiation shield apparatus must also provide adequate shielding while maintaining the necessary function qualities to workers that are inspecting or maintaining the steam generator component of a pressure water nuclear electric generating plant. It is very desirable to increase the shielding by placing a significant weight or mass in the path of the radiation, while keeping maintenance or inspection accessible. Shielding must be maintained while accessing the port.

The shielding must also be movable in a lateral or manipulated so as to remain between the worker and the radiation source while performing much of the work activity. Yet gravity that limits the amount of shielding that can be utilized due to the shielding having to be placed in a plane that is customarily offset. Openings or radiation paths that occur with any shield that is hinged from one side and must be manipulated or swung open for access, have to be avoided.

The worker can not maintain the shield between him and the radiation source(s) and still be able to swing the shield out from in front of the man-way opening in order to have access for lines and hoses leading to robotics, equipment for installing repair sleeves to eliminate leaking or failing tubes and other maintenance and inspection equipment.

Another object of the present invention is to address the demands of the Nuclear Regulatory Commission that requires all activities within the Radiological Controlled Area (RCA) be conducted with the goal that the radiation exposure to the nuclear workers be “as low as reasonably achievable” (ALARA). The worker can not maintain the shield between him and the radiation source(s) and still be able to swing the shield out from in front of the man-way opening in order to have access for lines and hoses leading to robotics, equipment for installing repair sleeves to eliminate leaking or failing tubes and other maintenance and inspection equipment.

### SUMMARY OF THE INVENTION

Among the many objectives of the present invention is the provision of a radiation shield apparatus with a track system on which at least one radiation shielding panel can be easily moved out of the way of the opening without having to overcome gravity.

Another objective of the present invention is the provision of a radiation shield apparatus to reduce the radiation exposure to nuclear workers and will overcome the deficiencies of the prior art devices.

Yet another objective of the present invention is to provide adequate shielding while maintaining the necessary function qualities to workers that are inspecting or maintaining the steam generator component of a pressure water nuclear electric generating plant.

Still another objective of the present invention is to increase the shielding which means placing significant weight or mass in the path of the radiation.

Also an objective of the present invention is the provision of a placement

A further objective of the present invention to be able to maintain the shielding effectiveness while accessing the man-way port.

Yet a further objective of the present invention is the provision of an apparatus to permit the shielding be moved laterally or manipulated so as to remain between the worker and the radiation source while performing much of the work activity.

A still further objective of the present invention is to eliminate the effects of gravity that limits the amount of shielding that can be utilized due to the shielding having to be placed in a plane that is customarily offset.

Another objective of the present invention is to eliminate the openings or radiation paths that occur with any shield that is hinged from one side and must be manipulated or swung open for access.

Yet another objective of the present invention is The worker can not maintain the shield between him and the radiation source(s) and still be able to swing the shield out from in front of the man-way opening in order to have access for lines and hoses leading to robotics, equipment for installing repair sleeves to eliminate leaking or failing tubes and other maintenance and inspection equipment.

Still another object of the present invention is to address the demands of the Nuclear Regulatory Commission that requires all activities within the Radiological Controlled Area (RCA) be conducted with the goal that the radiation exposure to the nuclear workers be “as low as reasonably achievable” (ALARA).

It is intended that any other advantages and objects of the present invention that become apparent or obvious from the detailed description or illustrations contained herein are within the scope of the present invention. These and other objectives of the invention (which other objectives become clear by consideration of the specification, claims and drawings as a whole) are met by providing apparatus for and method of shielding (reducing the radiation levels through the physics principle of attenuation) while permitting the required maintenance or inspection. The improved shielding specifically addresses the elevated radiation levels that occur when the access ports, commonly called “man-ways”, are opened in order to perform this maintenance and/or inspection.

### BRIEF DESCRIPTION OF THE DRAWINGS

Referring now, descriptively to the drawings, the attached industry introductory literature offers an overview of the invention with the benefit statements that are recognizable to the Nuclear Industry. The accompanying drawings illustrates the pertinent details that are important to the responsible Nuclear Plant Personnel that are the responsible for the work that is to be performed and the radiation protection that is to be offered during that work. The literature and accompanied drawing specifically addresses the questions such as; is the invention fully compatible with the equipment that is to be used for the inspection and/or maintenance and will the invention fit up to the steam generator man-way and will the invention provide the benefit that is claimed, specifically radiation dose reduction.

FIG. 1 is a perspective view of the Steam Generator Man-Way port with the cover plate removed. With the 10.2 centimeters (four inches) thick cover plate off, the radiation exposure levels in front of the opening is significantly elevated. The typical diameter of this opening is 40.8 centimeters (16 inches).

FIG. 2 is a photo of the prior art on a mockup illustrating the typical shielding approach that has been available to date that offers some shielding and still permits access.

FIG. 3 is a photo of the prior art in an actual radiation environment illustrating the access needs for the inspection and maintenance activities. Because the current man-way shielding is not providing adequate shielding, additional shielding in the form of lead blankets (yellow lead blanket panels) are needed and is a further complication when access requires the shield door to be opened. Hinges for the swing door are clearly shown in the photo.

FIG. 4 is a perspective view of the track and support frame of the invention illustrating how it is attached to the face of the man-way sealing surface about the opening. The track has a tube that is welded to a frame member with a minimum of 180 degrees of the tube clear for the roller to pass without coming in contact with the weldments and supporting members. The top and bottom track support members are secured using the available stud apertures that are available once the man-way cover is removed.

FIG. 5 is a perspective view of the top set of rollers that roll on the tubing or track member. The shield system has of two half doors. The illustration shows the set of rollers for the right primary shield panel.

FIG. 6 is a perspective view of the lower single roller that rolls on the bottom side of the lower track member and only provides a lateral positioning of the shield in close proximity to the surface of the man-way opening.

FIG. 7 is a front view of the primary shield panels, right half and left half, installed on the track member.

FIG. 8 is front view of the left shield panel door half with all three components of the installed. The lower hinged panel is open so as to permit the passage of lines and hoses into the man-way opening and still provide shielding.

FIG. 9 is a side view illustrating the sequence and method of assembling the components to complete each half shield door panel. The side shield is installed using a key type connection whereby the side shield panel has two carriage bolt heads that pass through the vertical angle and then lock in place when the side panel is moved down on the supporting angle.

FIG. 10 is a front view that shows the left lower hinged panel installed. This is the third component that when installed completes the shielded half door panel. The right side of the hinged panel connects into the primary shield panel half as it is assembled right to left. Simultaneous as the connection is made on the right side, the shaft on the left side of the hinged panel passes through a hole in the angle. The hinged or pivoting lower panel is retained by a retainer clip that is secured to the shaft that protrudes past the angle. The opening of the lower panel is preferably locked or secured with a lockable slide bolt.

Throughout the figures of the drawings, where the same part appears in more than one figure of the drawings, the same number is applied thereto.

### DESCRIPTION OF THE PREFERRED EMBODIMENTS

The invention provides an improved apparatus for and method of shielding (reducing the radiation levels through the physics principle of attenuation) while permitting the required maintenance or inspection. The improved shielding specifically addresses the elevated radiation levels that occur when the access ports, commonly called “man-ways”, are opened in order to perform this maintenance and/or inspection. Moreover it pertains specifically to an improved radiation shield apparatus that includes a track system on which radiation shielding panel or panels can be easily moved out of the way of the opening without having to overcome gravity. The shielding has one panel or two halves that, when moved, can provide partial or full access to the man-way port. Each of the shield panel includes a hinged lower section that can be opened as needed to permit insertion of inspection devices, including robotics and other equipment for the repair and/or inspection of the internals of the Steam Generator. This rolling shield system easily moves (rolls) across the face of the open port and permits the worker to manipulate the maintenance and/or inspection equipment as needed and still remain completely or partially behind the protective radiation shield.

In view of the limitations now present in the prior art, the present invention provides a new and useful radiation shielding apparatus which reduces the radiation dose received by the workers that are maintaining and/or inspecting PWR Steam Generator system. The improved shielding specifically addresses the elevated radiation levels that occur when the access ports, commonly called “man-ways”, are opened in order to perform this maintenance and/or inspection. The invention significantly decreases the radiation dose that the workers receive during all phases of work performed in the area of the “man-way” port. The existing shielding apparatus has a hinged shield that requires swinging out and away from the man-way port for access and therefore the workers are not able to “hide” behind the shield as they as they manipulate the maintenance/inspection equipment. Each opening and closing of the shield further exposes the worker to increased radiation levels due to the physical positions that the worker must assume in order to unlock, lock and manipulate this relatively heavy swinging shield door.

In addition, the effective shielding of the prior art system when fully installed is approximately ⅓ that of the present invention due to the fact that the face of the port is inclined downward by approximately 25 degrees and the existing shielding must overcome gravity in order to swing the door up and into position. Shield weight or mass in the path of the radiation is directly proportional to the effectiveness of the shielding. The swing door shield system's shielding effectiveness is compromised by the weight that can be safely and easily manipulated by the workers.

The purpose of the present invention is to provide a new radiation shield apparatus that reduces the radiation levels to the workers that are maintaining and/or inspecting PWR Steam Generator system. The improved shielding specifically addresses the elevated radiation levels that occur when the access ports, commonly called “man-ways” are opened in order to perform maintenance and/or inspection.

This device has many features not offered by the only prior art apparatus that result in a new and improved shielding apparatus that specifically addresses the elevated radiation levels that occur when the access ports, commonly called “man-ways”, are opened in order to perform this maintenance and/or inspection. The device is not apparent, obvious, or suggested, either directly or indirectly by any prior art apparatus for this specific shielding application.

The invention generally comprises a single or double shielded door panel, a right and a left half, that move across the man-way opening of the steam generator. Even though the invention includes the use of a single door that will move laterally on a track member, this description will detail the invention utilizing two doors or shield panel halves, a right half and a left half. The use of a double shield door or panel minimizes the amount of weight of any single component that must be handled by an individual nuclear worker.

These shielded door panel halves travel, by means of or on upper and lower rollers, on upper and lower track members. Each shielded door panel half has three parts, an upper primary shield panel that includes the rollers, a lower panel that is hinged off of the primary shield panel and a side shield that is also is attached to the primary shield panel. The assembled shielded door panel weighs significantly more than what can be easily handle and as described above must be assembled in place from three lighter weight component shield panel pieces. All of the shield panels have at least 2.5 centimeters (one inch) thick lead sheet or shielding equivalent to that of 2.5 centimeters (one inch) of lead and is contained in a metal covering such as stainless steel sheeting.

The goal is to improve the shielding quality of the shield which requires placing mass in the path of the radiation. The shield panel halves roll on an upper track that supports the weight and a lower track that maintains the shield at an angle from vertical and in close proximity to the plane of the man-way opening. The track and supporting frame is attached to the sealing surface that is around the man-way opening in the same location the approximately 10.2 centimeters (four inches) thick steel cover that has to be removed from the opening in order to perform the required maintenance and/or inspection. Four of the approximately 20 available stud apertures are used to secure the track support frame to the surface around the man-way opening.

The man-way opening is tipped downward by approximately 25 degrees. The current system utilizes a hinged shield that swings to one side only. The process of opening requires that gravity must be overcome because of the downward tipping and when the shield is swung away from the opening the workers in the area receive significant amount of radiation exposure. As stated previously, the amount of shielding is compromised in order to keep the weight at a manageable level.

The invention places the shielding halves on a level plain and therefore the amount of weight of the shielding doesn't impact the workers ability to move the shielding as needed for access. The invention reduces the radiation levels directly in front of the shield by a factor approximately three (3) compared to the existing shielding due directly to the amount of mass in the path of the radiation. In addition, the shielding may be moved in such as way that access to the man-way opening can often be accomplish while the worker remains behind one of the halves, this benefit cannot be accomplished with the swing door type shielding currently used.

The invention includes two rollers at the top of each half shield assembly that permits easy rolling, even with the necessary weight, on a track which is supported above the man-way opening. A single roller is located at the bottom corner of each shield halves and roll on the underside of the bottom track member. All of the weight of each shield assembly halves is carried by the upper track and the two rollers. The lower roller and track simply maintains the shield halves at the approximately 25 degree angle and in close proximity to the face of the man-way opening.

The foregoing has outlined, in general, the physical aspects of the invention and is to serve as an aid to better understanding the more complete detailed description which is to follow. In reference to such, there is to be a clear understanding that the present invention is not limited to the method or detail of construction, fabrication, material, or application of use described and illustrated herein. Any other variation of fabrication, use, or application must be considered apparent as an alternative embodiment of the present invention.

The invention includes placing adequate and useable shielding in the path of the radiation that exists when nuclear workers perform maintenance and inspection of the Pressure Water Reactor Steam Generator component at a nuclear electric generating plant. The invention permits placing an effective amount of shielding material or attenuating mass in the path of the radiation emanating from inside the steam generator. Implementing adequate shielding reduces the radiation exposure to those workers directly involved with the maintenance and/or inspection as well as workers in the immediate vicinity. The shielding has of an upper and lower track member that permit the two shield panel halves to roll easily and be manipulated so that access and the associated work to be performed will result in significant reduction to the typical radiation dose that the nuclear workers receive during this work evolution when compared current shielding approach. The shielding includes rollers that roll on track members that are located above and below the man-way opening.

The invention generally comprises a single or double shielded door panel, a right and a left half, that move across the man-way opening of the steam generator. Even though the invention includes the use of a single door that will move laterally on a track member, this description will detail the invention utilizing two doors or shield panel halves, a right half and a left half. The use of a double shield door or panel minimizes the amount of weight of any single component that must be handled by an individual nuclear worker (FIG. 9a and overview literature and accompanying drawing)

These shielded door panel halves travel, by means of or on upper and lower rollers, on upper and lower track members. Each shielded door panel half has three parts, an upper primary shield panel that includes the rollers, a lower panel that is hinged off of the primary shield panel and a side shield that is also is attached to the primary shield panel. The assembled shielded door panel weighs significantly more than what can be easily handle and as described above must be assembled in place from three lighter weight component shield panel pieces (FIG. 7 AND FIG. 8).

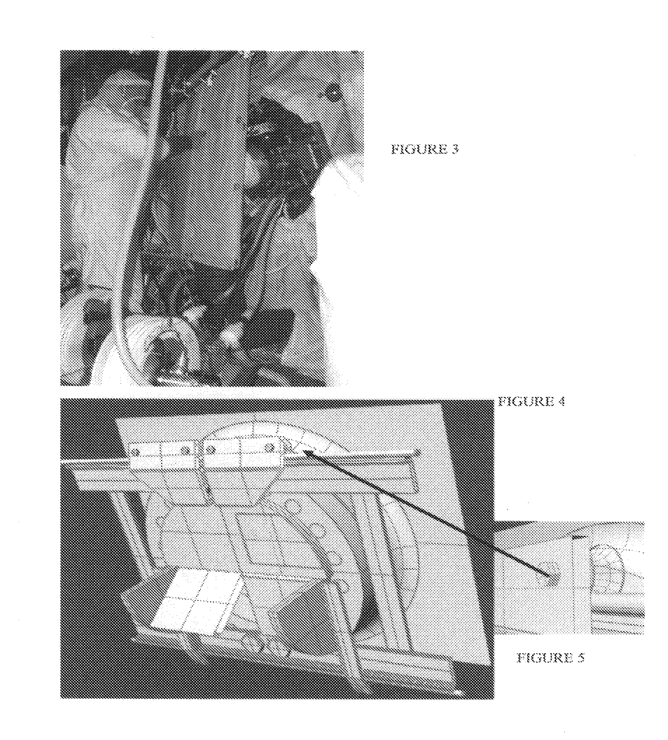

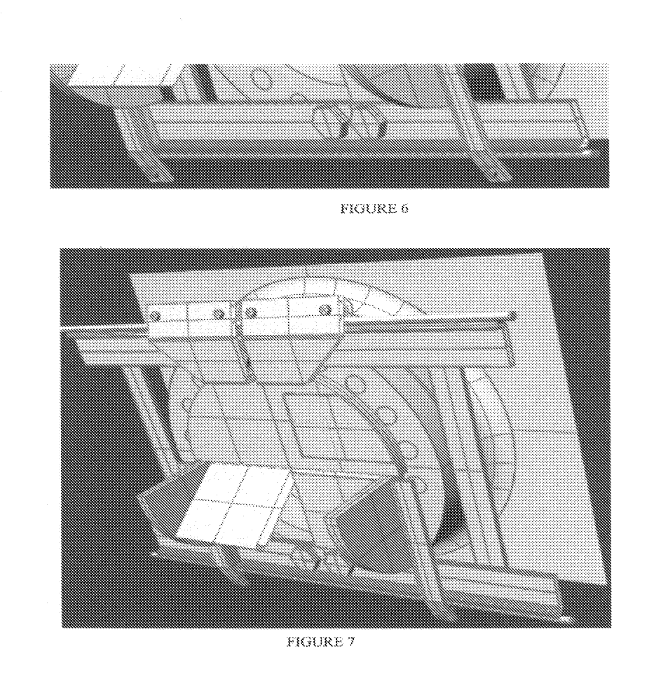

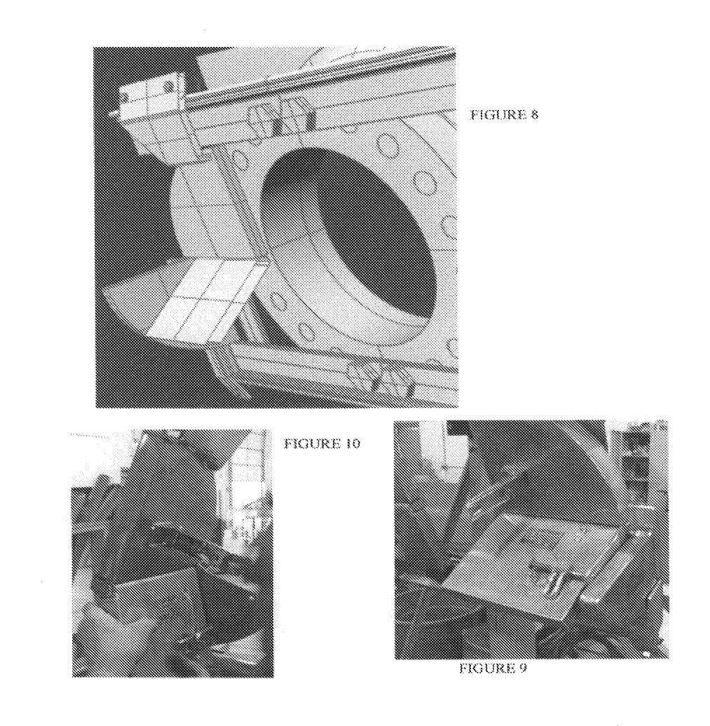

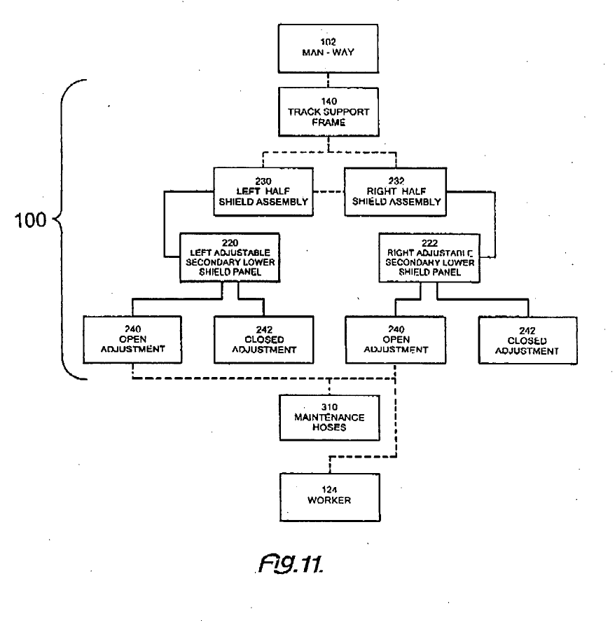

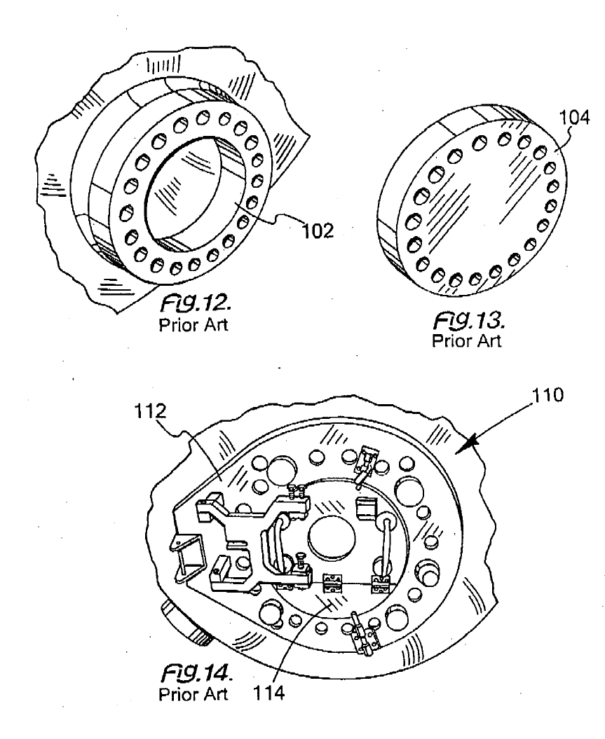

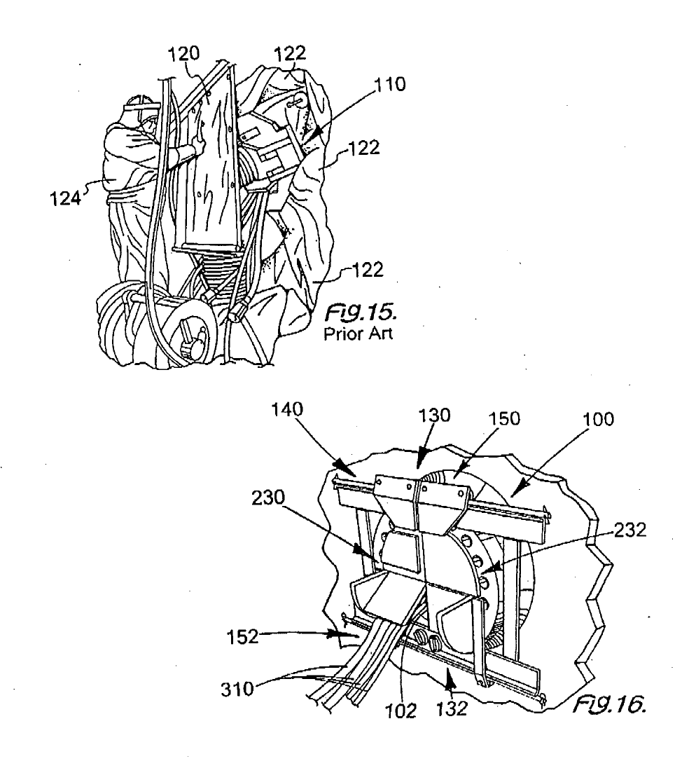

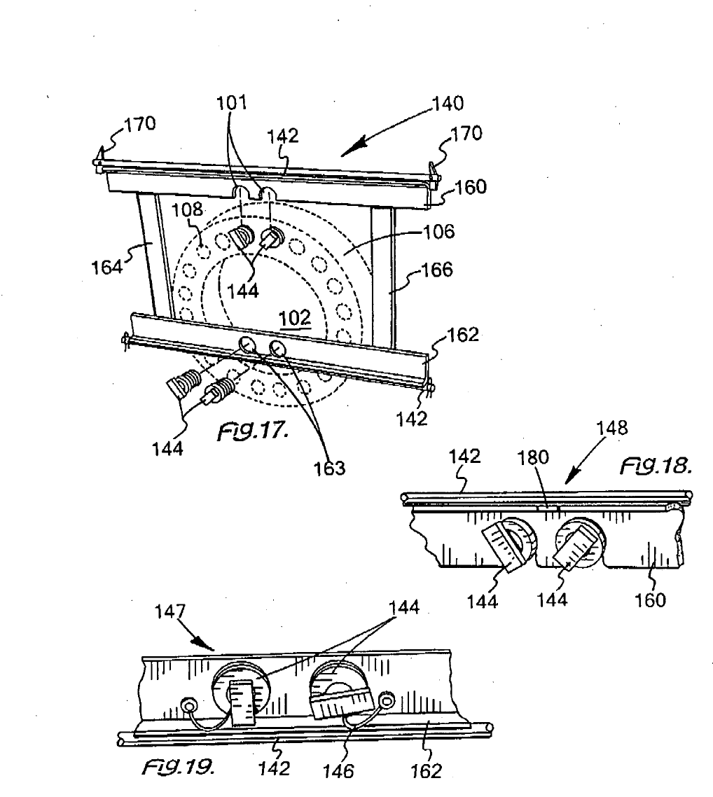

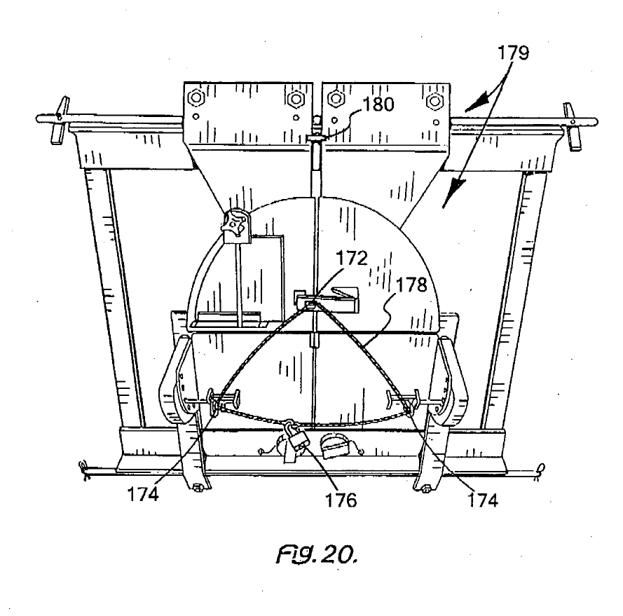

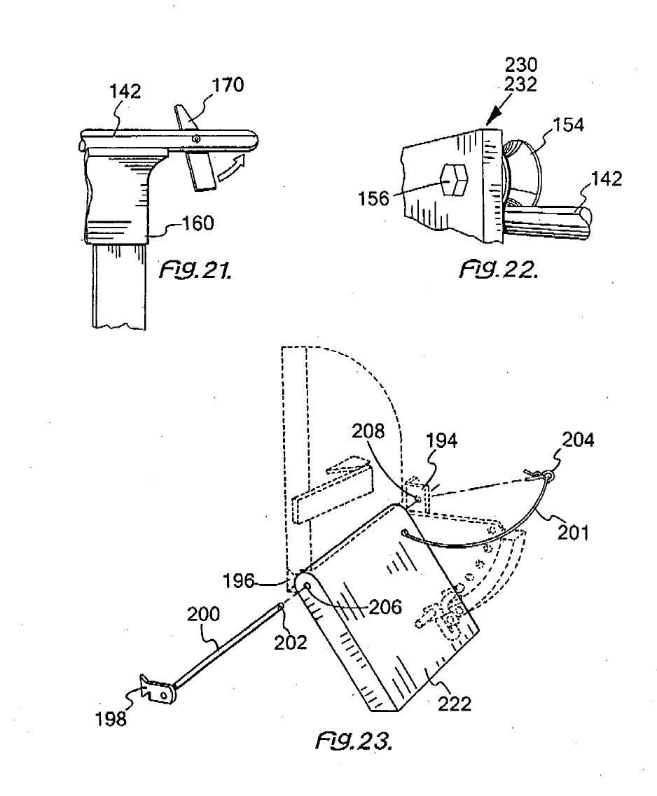

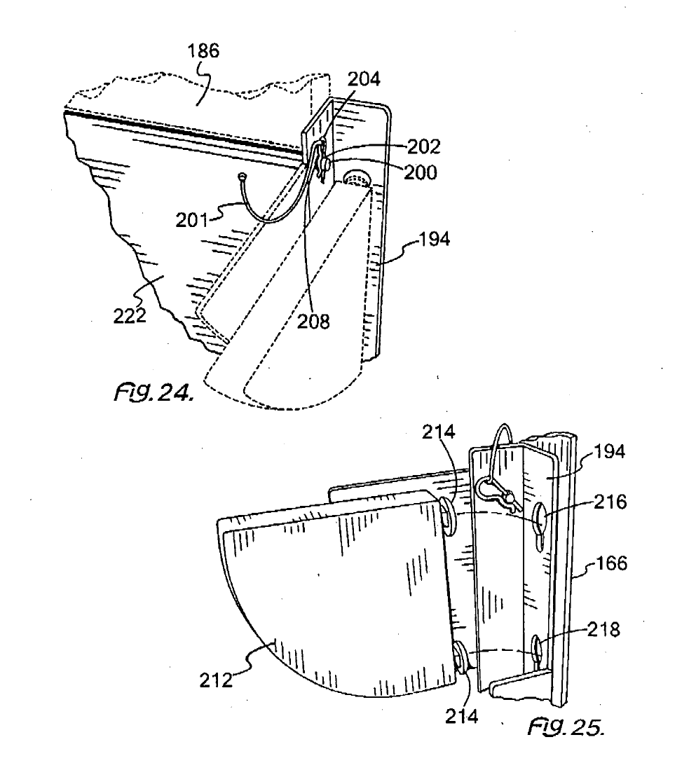

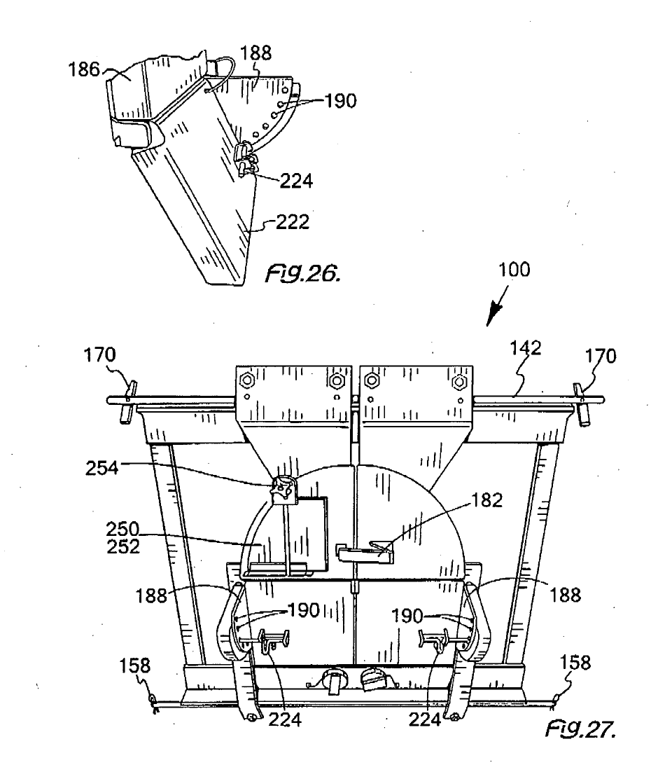

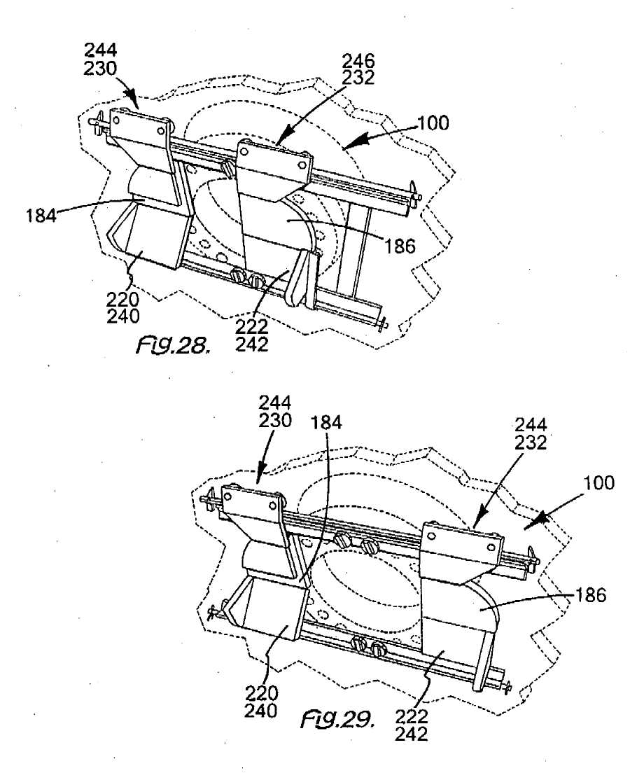

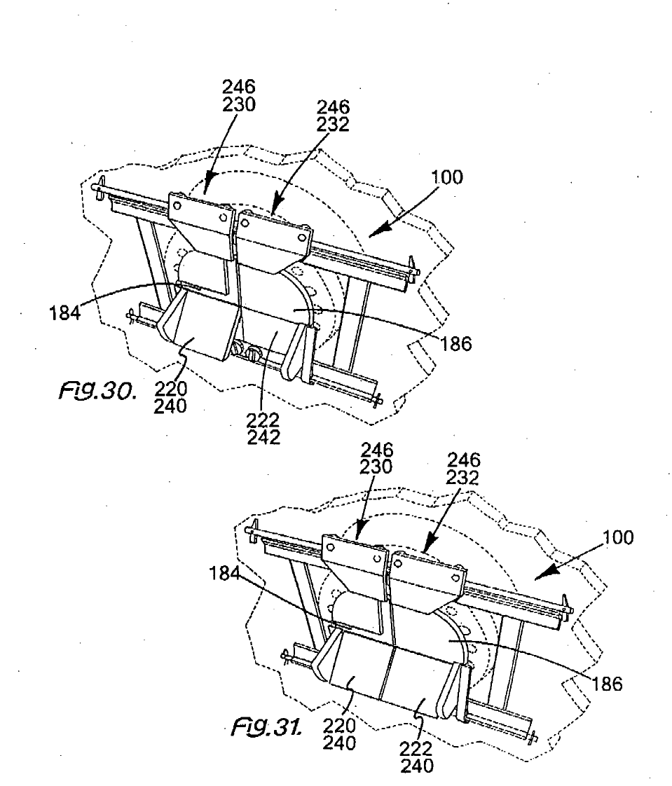

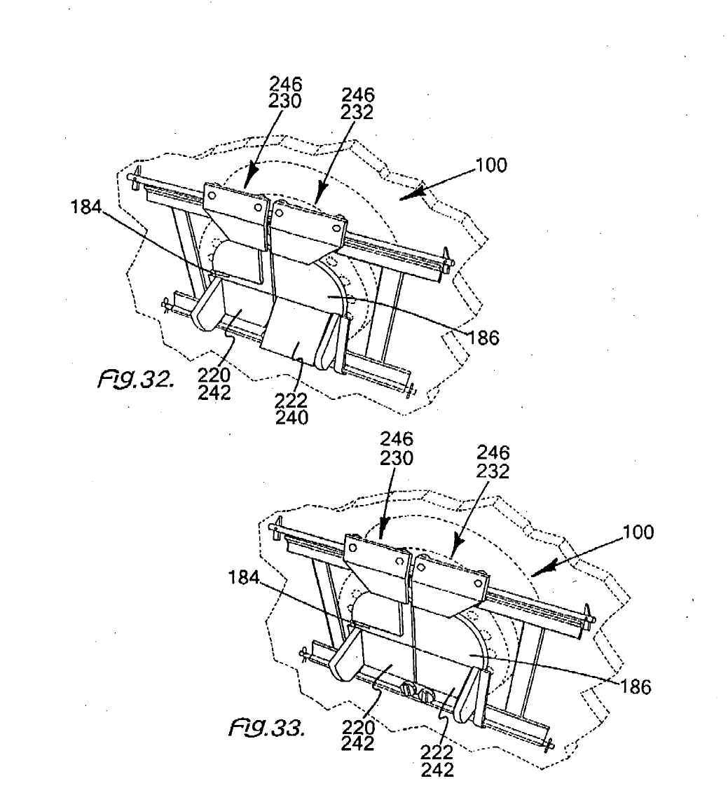

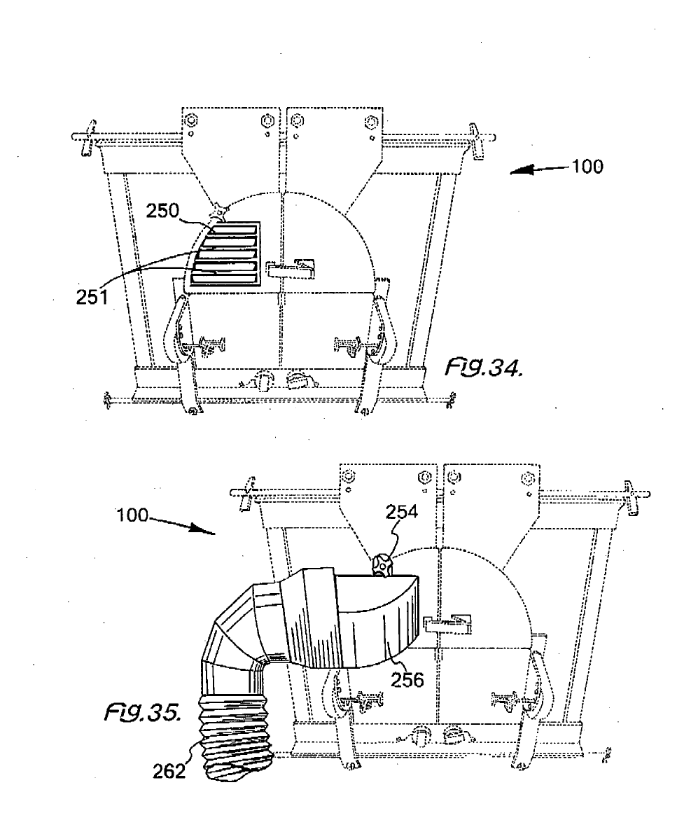

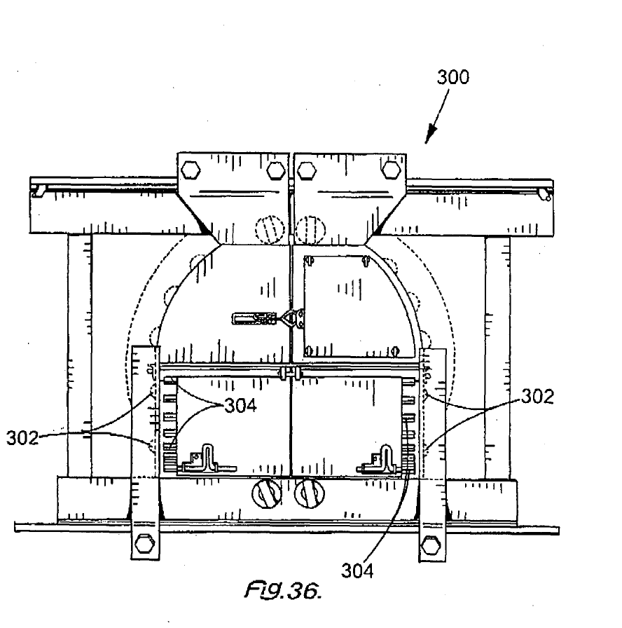

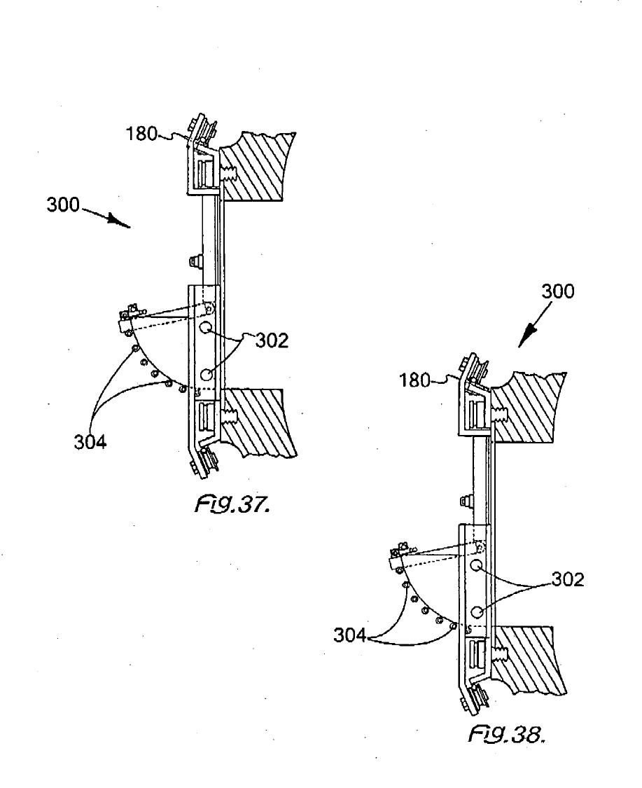

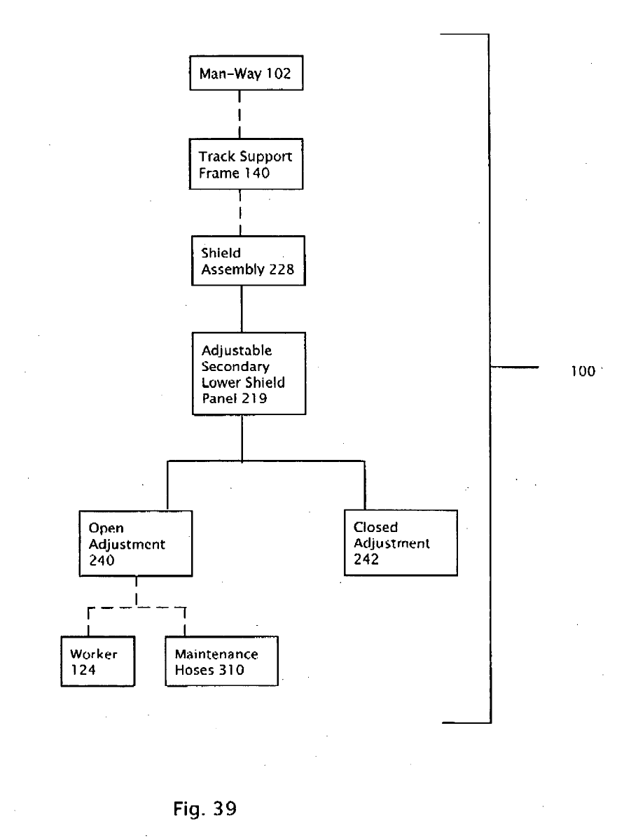

All of the shield panels have at least 2.5 centimeters (one inch) thick lead sheet or shielding equivalent to that of 2.5 centimeters (one inch) of lead and is contained in a metal covering such as stainless steel sheeting. The goal is to improve the shielding quality of the shield which requires placing mass in the path of the radiation. The shield panel halves roll on an upper track that supports the weight and a lower track that maintains the shield at an angle from vertical and in close proximity to the plane of the man-way opening (FIG. 4, FIG. 5 and FIG. 6).

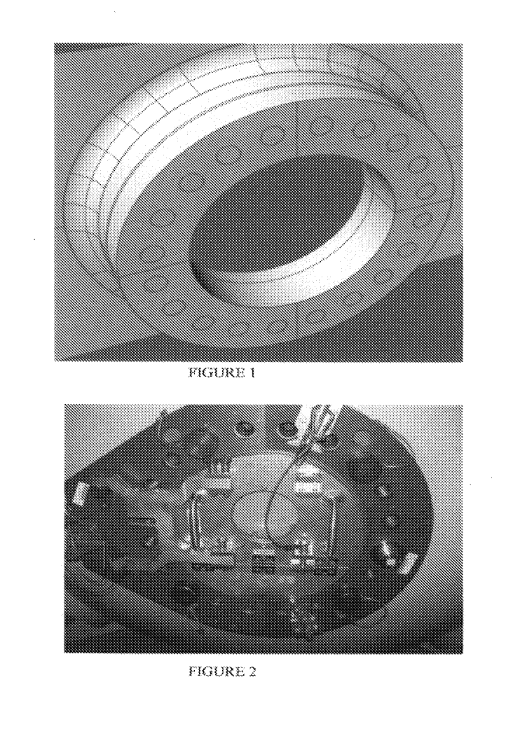

The track and supporting frame is attached to the sealing surface that is around the man-way opening in the same location the approximately 10.2 centimeters (four inches) thick steel cover that has be removed from the opening in order to perform the required maintenance and/or inspection (FIG. 1). Four of the approximately 20 available stud apertures are used to secure the track support frame to the surface around the man-way opening (FIG. 4).

The man-way opening is tipped downward by approximately 25 degrees. The current system utilizes a hinged shield that swings to one side only. The process of opening requires that gravity must be overcome because of the downward tipping and when the shield is swung away from the opening the workers in the area receive significant amount of radiation exposure. As stated previously, the amount of shielding is compromised in order to keep the weight at a manageable level (FIG. 2 and FIG. 3).

The invention places the shielding halves on a level plain and therefore the amount of weight of the shielding doesn't impact the workers ability to move the shielding as needed for access. The invention reduces the radiation levels directly in front of the shield by a factor approximately three (3) compared to the existing shielding due directly to the amount of mass in the path of the radiation. In addition, the shielding may be moved in such as way that access to the man-way opening can often be accomplish while the worker remains behind one of the halves, this benefit cannot be accomplished with the swing door type shielding currently used.

The invention includes two rollers at the top of each half shield assembly that permits easy rolling, even with the necessary weight, on a track which is supported above the man-way opening (FIG. 4 and FIG. 5). A single roller is located at the bottom corner of each shield halves and roll on the underside of the bottom track member (FIG. 6). All of the weight of each shield assembly halves is carried by the upper track and the two rollers. The lower roller and track simply maintains the shield halves at the approximately 25 degree angle and in close proximity to the face of the man-way opening.

The foregoing has outlined, in general, the physical aspects of the invention and is to serve as an aid to better understanding the more complete detailed description which is to follow. In reference to such, there is to be a clear understanding that the present invention is not limited to the method or detail of construction, fabrication, material, or application of use described and illustrated herein. Any other variation of fabrication, use, or application must be considered apparent as an alternative embodiment of the present invention.

It will also be understood that, in addition to impacting the radiation dose that the nuclear workers receive during the inspection and maintenance of the Steam Generator component of the Pressure Water Reactor (PWR) Nuclear Power Plant, the use of a roller track system for moving shielding have other beneficial applications in the nuclear facility. Shielding is typically of significant mass (the greater mass the great impact) and therefore the use of a transport such of a track greatly assists in installing the shielding material.

In addition, the actual installation process of the shielding material prior to any work or inspection is to be performed, must be considered as part of the total dose impact for the work to be performed and clearly a concern to the facility management and the Nuclear Regulatory Commission (NRC). Therefore, being able to implement a track system by which the shielding is installed in a low dose area and then moved by means of or on a track system of this invention to move the shielding material into position for the maximum radiation dose impact for the work or inspection that is to be performed.

It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention, particularly the use of a rolling shield that is mounted on a track type member.

This application—taken as a whole with the abstract, specification, claims, and drawings—provides sufficient information for a person having ordinary skill in the art to practice the invention disclosed and claimed herein. Any measures necessary to practice this invention are well within the skill of a person having ordinary skill in this art after that person has made a careful study of this disclosure.

Because of this disclosure and solely because of this disclosure, modification of this tool can become clear to a person having ordinary skill in this particular art. Such modifications are clearly covered by this disclosure.

What is claimed and sought to be protected by Letters Patent is:

1. A radiation shield door system for a steam generator comprising:
a) a track mounted door system reducing a radiation exposure of a worker as the worker performs maintenance or inspection of a steam generator;
b) the track mounted door system including an upper track, a lower track and at least one panel a door for the steam generator;
c) the door having at least one panel mounted on a panel hinge;
d) the at least one panel cooperating with the upper track and the lower track;
e) the track mounted door system reducing a radiation exposure of a worker as the worker performs a maintenance procedure on or the inspection of the steam generator; and
f) the track mounted door system being inclined downwardly at an angle from the vertical of about 25 degrees in order to facilitate movement of the radiation shield door system.

2. The radiation shield door system of claim 1 further comprising:
a) the upper track and the lower track cooperating to permit the at least one panel to roll away from an opening;
b) the opening being used for inspection or maintenance; and
c) the worker being at least partially protected by the panel; and
d) the upper track supporting a top edge of the at least one panel and the lower track support a bottom edge of the at least one panel.

3. The radiation shield door system of claim 2 further comprising:
a) the track mounted door system providing a single door or a door having a right half and a left half; and
b) the track mounted door system minimizing weight; of any single component of the radiation shield door system that must be handled by an individual nuclear worker.

4. The radiation shield door system of claim 3 further comprising
a) the at least one panel being mounted on at least one roller to cooperate with the upper track or the lower track;
b) the at least one panel forming a shield from radiation: and
c) the at least one panel providing access to repair or maintain a steam generator.

5. The radiation shield door system of claim 4 further comprising:
a) the at least one panel including a first half panel and a second half panel;
b) the first half panel being similar in structure to the second halt panel;
c) the first half panel having an upper primary shield panel, a lower panel and a side shield; and
d) the side shield being mounted in a perpendicular alignment to the upper primary shield panel and the lower panel.

6. The radiation shield door system of claim 5 further comprising:
a) the upper primary shield panel including a set of rollers;
b) the lower panel being hinged of the upper primary shield panel; and
c) the side shield being attached to the primary shield panel.

7. The radiation shield door system of claim 6 further comprising:
a) the at least one panel being assembled in place from the upper primary shield panel, the lower panel and the side shield to form a protecting assembly;
b) the upper primary shield panel, the lower panel and the side shield individually being lighter weight than the protecting assembly;
c) the protecting assembly traveling on a set of upper rollers in an upper track member or on a set of lower rollers in a lower track member;
d) the upper track member supporting a weight of the at least one panel; and
e) the lower track member maintaining the at least one panel at an angle from vertical and in close proximity to a plane of an opening the steam generator in order to permit maintenance or repair thereof.

8. In a steam generator component of a nuclear reactor having a removable radiation shield door system covering an opening in the steam generator with a frame around the opening, the improvement comprising:
a) a track mounted door system reducing a radiation exposure of a worker as the worker performs maintenance or inspection of a steam generator;
b) a track assembly for the track mounted door system;
c) the frame having a plurality of stud apertures therein;
d) the track assembly mounted in some of the plurality of stud apertures;
e) the track mounted door system providing a single door or a door having a right half and a left half;
f) the track mounted door system supporting weight of any single component of the door system that must be handled by a nuclear worker in order to facilitate movement thereof for the nuclear worker during a maintenance procedure or an inspection of the steam generator;
g) the upper track being place on the top edge;
h) the lower track on the bottom edge of the secured panel; and
g) the upper track supporting a top edge of the at least one panel and the lower track support a bottom edge of the at least one panel.

9. The steam generator of claim 8 further comprising:
a) the track mounted door system reducing a radiation exposure of a worker as the worker performs the maintenance procedure on or the inspection of the steam generator;
b) the at least one panel being mounted on a panel hinge; and
c) the at least one panel cooperating with the upper track and the lower track.

10. A radiation shield door system for a steam generator component of a nuclear reactor comprising:
a) a track mounted door system reducing a radiation exposure of a worker as the worker performs maintenance or inspection of a steam generator;
b) the track mounted door system including a track system with a shield system mounted thereon;
c) the shield system including at least one panel;
d) the at least one panel being mounted on a panel hinge;
e) the shield system cooperating with the track system;
f) the track mounted door system being inclined downwardly at an angle from the vertical of about 25 degrees in order to facilitate movement of the radiation shield door system; and
g) the track system permitting the at least one panel to be easily moved.

11. The radiation shield door system of claim 10 further comprising:
a) the track system reducing the effect of gravity oil the shield system;
b) the shield system including at least one panel;
c) the shield system being movable in order to provide access through a man way of the steam generator for repair or inspection;
d) the shield system providing partial or full access to the man-way port; and
e) a face of the man-way port being inclined downwardly at an angle from the vertical of about 25 degrees.

12. The radiation shield door system of claim 11 further comprising:
a) the shield system having at least one panel;
b) the at least one panel providing partial or full access to the man-way port when moved from the man-way port;
c) the at least one panel including a hinged lower section be openable as needed to permit insertion into the man-way port of an inspection device or a repair device usable with the steam generator;
d) the shield system being rollable when moved; and
e) the rolling shield system permitting a worker to manipulate the repair device or the inspection device as needed while remaining completely or partially behind the shield system.

13. The radiation shield door system of claim 12 further comprising:
a) the at least one panel including a right panel and a left panel in order to minimize an amount of weight of to be handled by the worker;
b) the right panel and the left panel including an upper primary shield panel, a secondary lower shield panel and a side shield;
c) the upper primary shield panel that including at least one roller to facilitate the movement thereof;
d) the secondary lower shield panel being movably secured to the upper primary shield panel with a hinge; and
e) the side shield being attached to the upper primary shield panel; and
f) the side shield being mounted in a perpendicular alignment to the upper primary shield panel.

14. The radiation shield door system of claim 13 further comprising:
a) the right panel and the left panel having a shielding equivalent to at least about 2.5 centimeters thick lead sheet of lead;
b) the right panel and the left panel being contained in a metal covering;
c) the track system having an upper track mounted at a top portion of the man way and a lower track mounted at a bottom portion of the man-way;
d) the upper track supporting a weight the right panel and the left panel;
e) the lower track supporting the right panel and the left panel in order to maintain the right panel and the left panel at an angle from vertical and in close proximity to a plane of the marl-way opening;
f) the right panel and the left panel each having two rollers at a top panel portion and a single roller at a bottom panel portion;
g) the two rollers supporting the weight the right panel and the left panel;
h) the single roller supporting an angle for the right panel and the loft panel; and
i) the right panel and the left panel being movable separately to provide access through a man-way for repair or inspection while protecting the worker.

15. In a steam generator component of a nuclear reactor having a man-way for access in order to repair or maintain the steam generator with a sealing surface around the man-way the improvement comprising:
a) a track mounted door system reducing a radiation exposure of a worker as the worker performs maintenance or inspection of the steam generator;
b) the track mounted door system including a track system mounted on the sealing surface
c) a shield system mounted on the track system;
d) the shield system including at least one panel;
e) the shield system cooperating with the track system;
f) the track system permitting the at least one panel to be easily moved;
g) the at least one panel being mounted on a panel hinge;
h) the track system reducing the effect of gravity on the shield system;
i) the shield system including at least one panel;
j) the shield system being movable in order to provide access through a man-way of the steam generator for repair or inspection;
k) the shield system providing partial or full access to the man-way port; and; and
l) the shield system on the man-way port being inclined downwardly at an angle from the vertical of 25 degrees.

16. The steam generator of claim 15 further comprising:
a) the at least one panel providing partial or full access to the man-way port when moved from the man-way port;
b) the at least one panel including a hinged lower section be openable as needed to permit insertion into the man-way port of an inspection device or a repair device usable with the steam generator;
c) the shield system being rollable when moved;
d) the rolling shield system permitting a worker to manipulate the repair device or the inspection device as needed while remaining completely or partially behind the shield system;
e) the at least, one panel including a right panel and a left panel in order to minimize an amount of weight of to be handled by the worker;
f) the right panel and the left panel including an upper primary shield panel, a secondary lower shield panel and a side shield;
g) the upper primary shield panel that including at least one roller to facilitate the movement thereof;
h) the secondary lower shield panel being movably secured to the upper primary shield panel with a hinge;
i) the side shield being attached to the upper primary shield panel;
j) the right panel and the left panel having a shielding equivalent to at least about 2.5 centimeters thick lead sheet of lead; and
k) the side shield being mounted in a perpendicular alignment to the upper primary shield panel.

17. The steam generator of claim 16 further comprising:
a) the right panel and the left panel being contained in a metal covering;
b) the track system having an upper track mounted on the sealing surface at a top portion of the man-way and a lower track mounted on the sealing surface at a bottom portion of the man-way;
c) the upper track supporting a weight of the right panel and the left panel;
d) the lower track supporting the right panel and the left panel in order to maintain the right panel and the left panel at an angle from vertical and in close proximity to a plane of the man-way opening;
e) the right panel and the left panel each having two rollers at a top panel portion in contact with the upper track and a single roller at a bottom panel portion in contact with the lower track;
f) the two rollers supporting the weight the right panel and the left panel;
g) the single roller supporting an angle for the right panel and the left panel;
h) the right panel and the left panel being movable separately to provide access through a man-way for repair or inspection while protecting the worker;
i) the two rollers permitting easy rolling of the right panel or the left panel; and
j) an adjustment means positioning the shield system in a desired position.

18. The steam generator of claim 17 further comprising:
a) the secondary lower shield panel for the left panel being a left adjustable secondary lower shield panel;
b) the secondary lower shield panel for the right panel being a right adjustable secondary lower shield panel;
c) the right panel acting as a right half shield assembly;
d) the left panel acting as a left half shield assembly;
e) the left half shield assembly and the right half shield assembly cooperating to open or close the man-way;
e) the left adjustable secondary lower shield panel and the right adjustable secondary lower shield panel each having an open adjustment position and a closed adjustment position;
f) the open adjustment providing for access to perform maintenance or repair of the steam generator;
g) the upper track and the lower track forming a track support frame;
h) the track support frame being substantially rectangular in shape;
i) the upper track forming a Lop cross member;
g) the lower track forming a bottom cross member; and
i) the upper track being oppositely disposed from the lower track.

19. The steam generator of claim 18 further comprising:
a) the sealing surface being a flange around the man-way;
b) the flange including a plurality of threaded apertures;
c) the threaded apertures receiving stud bolts;
d) the top cross member having alignment slots;
e) each of the alignment slots receiving one of the stud bolts in order to guide the correct and precise positioning of track support frame;
f) the stud bolts being tightened once the track support frame in order to secure the same;
g) the bottom cross member having bottom apertures adapted to receive the stud bolts in order to secure bottom cross mender to the flange;
h) the top cross member including a track bar with a track roller stop in order to limit the movement of the right panel or the left panel;
i) a through bolt tether permanently affixing each of the stud bolts to the bottom cross member;
j) the two rollers at the top panel portion assembly functioning as a top support roller assembly in contact with the upper track; and
k) the single roller at the bottom panel portion assembly functioning as a guide roller assembly in contact with the lower track.

20. The steam generator of claim 19 further comprising:
the two rollers being upper rollers;
the upper rollers forming part of a top support roller assembly;
the single roller forming part of a bottom guide roller assembly;
the bottom guide roller assembly further including a track bar;
the bottom guide roller assembly and the top support roller assembly being perpendicular to the man-way while permitting the shield system to be angled on the man-way
the secondary lower shield panel of the right panel being a right adjustable secondary lower shield panel;
the secondary lower shield panel of the right panel including a hinge sleeve;
the right primary shield panel being secured to the angle steel;
the hinge sleeve being aligned will a hinge end aperture in order to slide a hinge pin through the hinge sleeve and the hinge end aperture in order to connect the right adjustable secondary lower shield panel and right primary shield panel;
the hinge pin being secured through the interaction of a pin aperture therein with a pin clip therethrough;
the angle steel having an upper key slot and a lower key slot;
the right secondary shield panel including a pair of carriage-type bolt heads;
the pair of carriage-type bolt heads cooperating with the upper key slot and the lower key slot in order to form a secure and releaseable connection between the right secondary shield panel and the angle steel;
the left adjustable secondary lower shield panel and the right adjustable secondary lower shield panel being jointly or severally opened or closed.
